(19) United States
(12) Patent Application Publication
(10) Pub. No.: US 2007/0099042 A1
(43) Pub. Date: May 3, 2007

(54) Fuel supply control system for fuel cell systems and the fuel supply control methodology thereof

(76) Inventor: Chun-Chin Tung, Taipei (TW)

Correspondence Address: G. LINK CO. LTD., 3550 BELL ROAD, MINOOKA, IL, 60447, US

(21) Appl. No.: 11/263,934

(22) Filed: Nov. 2, 2005

(51) Int. Cl. H01M 8/04

(52) U.S. Cl. 429/22; 429/34; 429/13

(57) ABSTRACT

The present invention provides a fuel supply control system for fuel cell systems and the fuel supply control methodology thereof, comprising an anode reactant tank having water level sensors at an equidistant scale, wherein water level sensors at an equidistant scale are divided into 20 sensation levels, with the 0 level located at the bottom of the anode reactant tank and the 19^{th} level located at the 5% location below the top of the anode reactant tank. In addition, the present invention also comprises a micro-processing control circuit, which is used to analyze the electronic signals transmitted back from the water level sensors at an equidistant scale. As the electronic signals indicate the concentration level inside the anode reactant tank, through the analysis of the concentration level, it is to determine whether fuel supply needs to be increased or terminated. Through another circuit of electronic signals, it is to control the switch of a control valve, which is a feeding mechanism that controls the fuel tank and the anode reactant tank.

### FIELD OF THE INVENTION

The present invention relates to a fuel supply control system for fuel cell systems and the fuel supply control methodology thereof, characterized in which fuel concentration in the fuel cell can be effectively monitored and refilled, so as to make the fuel cell functioning at stable efficiency.

### BACKGROUND OF THE INVENTION

A conventional fuel cell forms a current loop by the oxidation and reduction of hydrogen-containing fuel such as methanol, so as to provide electrical power. In the fuel supply control methodology, a high-level sensor and a low-level sensor are used to determine if a timely addition of high-concentration methanol changes the methanol concentration in the entire anode reactant tank, because of changes in concentration. However, the detection of only the high level and the low level is present in the prior art. In addition, no flexible adjustment mechanism is present in the prior art. In addition, general in-built metallic electrical sensors are used as sensors, so that they unavoidably have chemical contact with an anode reactant tank. The present invention has improved three shortcomings present in the prior art as follows: (1) To achieve more flexible concentration adjustment, the anode reactant tank is divided into 20 levels, and each level represents 5% fuel concentration level. It is also possible to designate a high level and a low level through a control circuit, so as to meet the requirements for any load. (2) The in-built contact sensor is improved by using non-contact photo-interrupting devices, which are disposed at the two sides of the anode reactant tank. As the anode reactant tank is a transparent device, through the monitoring of the photo-interrupting devices by a control circuit, it is to determine if optical signals have passed through, and then the location of the current concentration level is analyzed. The photo-interrupter is a non-contact sensor, which is not subjected to the effects of the chemical solution inside the anode reactant tank. (3) The control circuit comprises a micro-processing control device, which can be set to store the relative location of the designated high level and low level, and process photo-interrupting signals and the switch of an electromagnetic valve, so as to achieve programmable control. Next, through the analysis and quantification of the micro-processing control device, values can be quantified and displayed on a screen, so that users can directly observe the residual fuel amount. The present invention can be applied for the fuel control of fuel cells at any load, and is not limited to a fixed format. Therefore, the present invention is flexible.

### SUMMARY OF THE INVENTION

It is a primary objective of the present invention to provide a fuel supply control system for fuel cell systems and the fuel supply control methodology thereof, so that the fuel concentration inside a fuel cell can be kept constant when the fuel cell is generating electrical power, and moreover, through the analysis and control of a microprocessor, the entire fuel cell system can be flexibly controlled.

Wherein the fuel supply control system of the fuel cell system comprises 20-level sensors. In other words, 20 sensors are disposed on the exterior of the two sides of an anode reactant tank respectively. In addition, the sensors at the same concentration level on the two sides are located at the same level. The 20-level sensors operate on non-contact photo-interrupting devices, which will transmit the electronic signals that they have sensed via an electronic loop to the micro-processing controller. This is a one-way signal transmission that is intended to notify the micro-processing controller of the current fuel concentration level inside the anode reactant tank. In addition, wherein a sensor is formed by a photo-interrupting device, which comprises a transmitter and a receiver, which are disposed on the two sides of the anode reactant tank respectively. When fuel exceeds the level of the sensor, optical signals are unable to be transmitted to a corresponding photo-receiver because of the refraction of optical signals by the liquid surface. Therefore, the optical signals are transmitted back to the micro-processing control device via the electronic loop, and then analyzed to determine its concentration level. Furthermore, as the anode reactant tank comprises 20 levels, all the photo-interrupting control devices can be analyzed together to obtain the current concentration. On the other hand, if optical signals can be transmitted to the corresponding photo-receiver, and then transmitted back to the micro-processing control device via the electronic loop, it is possible to know that the fuel in the anode reactant tank has been lower than this concentration level. In other words, the concentration has become lower than this concentration. As the sensation range consists of 20 levels, each level is determined by a concentration level, with each 5% concentration set as one sensation range. The 0-level sensor is set at the bottom of the anode reactant tank, whereas the 19^{th} level sensor is set at 5% location below the top of the anode reactant tank. This type of sensation is called non-contact sensation, which is not subjected to the effects of the fuel inside the anode reactant tank.

Furthermore, the micro-processing controller is controlled by an SMBUS interface. SMBUS stands for System Management Bus and is an interface jointly developed by Intel Corporation and Duracell, while designing a smart battery for use in notebooks. It was developed in the PC era, and the specifications of Advanced Configuration & Power Interface (ACPI) have become basic specifications for management information communication interfaces and control communication interfaces, wherein the SMBUS comprises two main pins, SMBDATA and SMBCLK, which are for data and clock communication respectively. Other devices can communicate with this chip through the SMBUS to obtain temperature and related information or proceed with command control. In addition, the micro-processing controller is responsible for analyzing the photo-interrupted signals transmitted back from electronic loops and then quantifying the signals into values, which are then sent to a screen, so that the fuel concentration level inside the anode reactant tank can be known by users so as to timely prepare reserve fuel. When reserve fuel is disposed in the fuel inlet of the anode reactant tank, the opening and closing of the open valve is controlled by the micro-processing controller. In addition, the open control of the micro-processing controller is determined by the detection results of the pre-set concentration level, and this concentration level can be flexibly set by the fuel cell provider to maintain optimum fuel cell performance status.

### BRIEF DESCRIPTION OF THE DRAWINGS

The above objects and advantages of the present invention will become more apparent with reference to the appended drawings wherein:

FIG. 1 is a fuel supply control system of the fuel cell system of the present invention.

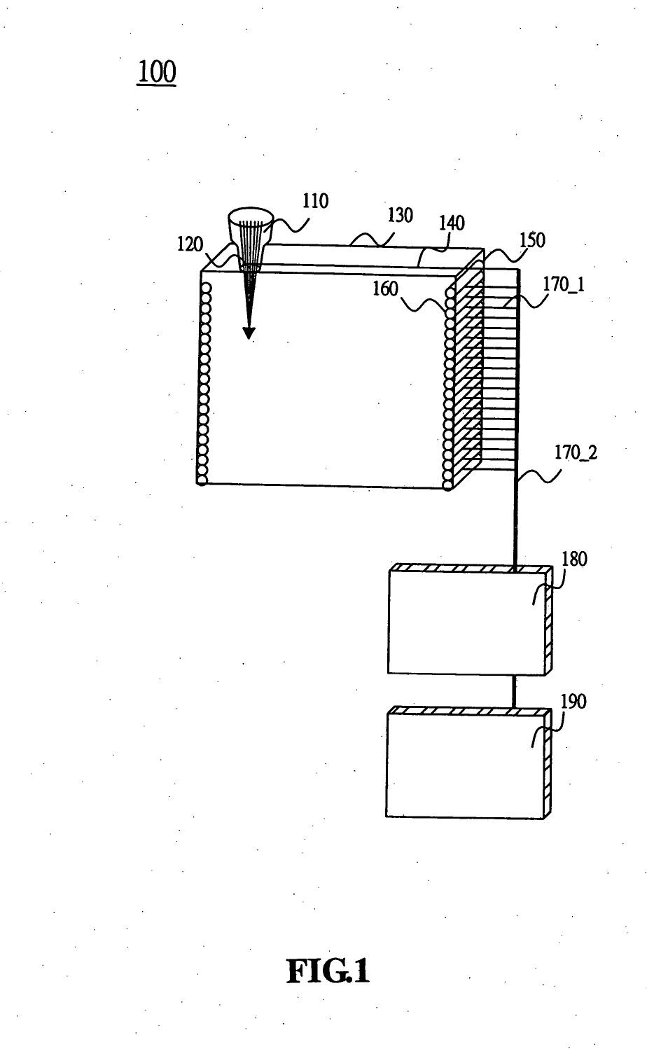

### DETAILED DESCRIPTION OF THE INVENTION

The present invention provides a fuel supply control system for fuel cell systems and the fuel supply control methodology thereof. The present invention comprises a fuel supply control system 100, having four portions, wherein a first portion is an anode reactant tank 130, having 20 photo-interrupting devices, each of which is divided into two portions: a photo-transmitting portion 160 and a photo-receiving portion 150, which are at the same level in a one-to-one relationship. At the other side, there are the same photo-interrupting devices, which also consist of the photo-transmitting portion 160 and the photo-receiving portion 150, which are also at the same level and are also divided into 20 levels, ranging from the 0 level to the 19^{th} level. Each level designates a 5% pres-set concentration level, so the concentration level range can be designated from 0% to 95%. For example, let the fuel in the anode reactant tank 130 be 60%. In other words, the fuel is then located on the photo-receiving portion 150 and the photo-transmitting portion 160 of the 12^{th}-level photo-interrupting device. Then in the photo-interrupter, the photo-transmitter 160 transmits a light source, in order that the corresponding photo-receiver 150 may receive a signal indicative of the light source. However, as the fuel level in the anode reactant tank 130 happens to be at the 60% level, lights are unable to correctly impinge on the corresponding photo-receiver 150, because liquid causes different refraction indexs. On the other hand, if lower than this liquid level, lights can normally reach the photo-receiver 150 from the photo-transmitter 160. Based on this action principle, the current concentration level can thus be obtained. In addition, these electronic signals are transmitted to a main electronic loop 170_2 via an electronic loop 170_1, and next to a micro-processing controller 180, which then analyzes, and depending on conditions, emits messages indicative of the need for reserve fuel 110. This way, when the reserve fuel 110 is refilled, an electronic valve 120 is opened by the micro-processing controller 180, so that the reserve fuel 110 enters the anode reactant tank 130 to achieve fuel refilling. In addition, the micro-processing controller 180 analyzes and converts the fuel concentration, that is the level transmitted back from the photo-receiver 150 and the photo-transmitter 160 of the photo-interrupting devices, and then displays the quantified values on a screen 190. This way, users can know the current fuel concentration level and then add reserve fuel 110 timely.

It is to be understood that the foregoing description of the present invention should not be based to restrict the invention, and that all equivalent modifications and variations made without departing from the intent and import of the foregoing description should be included in the following claim.

What is claimed is:

1. A fuel supply control system for fuel cell systems, comprising:
an anode reactant tank having 20-level sensors ranging from the 0 level to the 19^{th} level, with each level equivalent to 5% fuel concentration, wherein the 0 level sensor is located at the bottommost portion of the anode reactant tank, and the 19^{th} level sensor is located at the 5% location below the top of the anode reactant tank, and moreover, the 0 level sensor and the 19th level sensor indicate the highest level and the lowest level respectively; and
a sensor having two portions, which are a transmitter and a receiver respectively, both of which are connected to an electronic loop, through which signals are transmitted to a micro-processing controller.

2. The fuel supply control system as claimed in claim 1, wherein the sensors are a pair of photo-interrupting devices.

3. The fuel supply control system as claimed in claim 2, wherein the photo-interrupting device is formed by a photo-transmitter and a photo-receiver.

4. The fuel supply control system as claimed in claim 1, wherein for the range of 20 levels, each level is 5% fuel concentration, so fuel can range from 5% to 100% concentration.

5. A fuel supply control methodology for fuel cell systems, comprising the following steps:
primarily having a micro-processing controller, which receives electronic signals from the photo-interrupting devices, and the electronic signals are provided by each level and then analyzed by the micro-processing controller so as to obtain the current fuel concentration inside the anode reactant tank; the concentration so obtained determines whether reserve fuel can enter an interior of the anode reactant tank via the opening of a control valve as refilled fuel; by setting the concentration level inside the micro-processing controller, a certain concentration is determined so that the control valve is opened at this concentration, wherein the micro-processing controller can quantify the fuel concentration inside the anode reactant tank into values, which are then displayed on a screen.

6. The fuel supply control methodology as claimed in claim 5, wherein the micro-processing controller is controlled by an SMBUS chip.

7. The fuel supply control methodology as claimed in claim 5, wherein the control valve is an electronic control valve, which opens on receipt of a signal, so that fuel from reserve fuel enters the anode reactant tank.

8. The fuel supply control methodology as claimed in claim 5, wherein the screen system can be a LCD display, a 7-segment display, or a LED display.
